(19) United States
(12) Patent Application Publication
(10) Pub. No.: US 2017/0186042 A1
(43) Pub. Date: Jun. 29, 2017

(54) SYSTEMS AND METHODS FOR PROMOTING CONTENT ITEMS

(71) Applicant: Facebook, Inc., Menlo Park, CA (US)

(72) Inventors: James Wah Hou Wong, Bellevue, WA (US); Jinyi Yao, Issaquah, WA (US); Hannah Marie Hemmaplardh, Seattle, WA (US); Bradley Ray Green, Snohomish, WA (US)

(21) Appl. No.: 14/980,677

(22) Filed: Dec. 28, 2015

(51) Int. Cl. G06Q 30/02; G06Q 50/00

(52) U.S. Cl. CPC G06Q 30/0269; G06Q 30/0255; G06Q 50/01

(57) ABSTRACT

Systems, methods, and non-transitory computer-readable media can determine a content item to be promoted to one or more users of the social networking system. At least one seed content item in the social networking system that is similar to the content item to be promoted can be determined. A set of interests can be determined based at least in part on the at least one seed content item. One or more interests in the set can be determined as suggestions for promoting the content item to users, wherein promoting the content item using a first interest causes the content item to be presented to users of the social networking system that are associated with the first interest.

### FIELD OF THE INVENTION

The present technology relates to the field of content promotion. More particularly, the present technology relates to techniques for promoting content items.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

In some instances, advertisements can be presented to users of the social network. Advertisements may be linked to various content items, such as websites, for example. Typically, the advertisements presented to users can be tailored, for example, based on topics that are determined to be of interest to the user. Often, the advertisement includes a hypertext link or other user-selectable element that enables the user to navigate to another page or display relating to the advertisement.

### SUMMARY

Various embodiments of the present disclosure can include systems, methods, and non-transitory computer readable media configured to determine a content item to be promoted to one or more users of the social networking system. At least one seed content item in the social networking system that is similar to the content item to be promoted can be determined. A set of interests can be determined based at least in part on the at least one seed content item. One or more interests in the set can be determined as suggestions for promoting the content item to users, wherein promoting the content item using a first interest causes the content item to be presented to users of the social networking system that are associated with the first interest.

In an embodiment, the content item is one of a page accessible through the social networking system, a website associated with a page that is accessible through the social networking system, or a post that is accessible through the social networking system.

In an embodiment, the systems, methods, and non-transitory computer readable media are configured to determine a set of topic tags using the at least one seed content item, wherein each topic tag describes subject matter reflected in the seed content item, and wherein each topic tag corresponds to an interest.

In an embodiment, the systems, methods, and non-transitory computer readable media are configured to determine one or more interests that are used to target fans of the at least one seed content item.

In an embodiment, the systems, methods, and non-transitory computer readable media are configured to determine one or more interests that have previously been used to promote the at least one seed content item over a period of time.

In an embodiment, the systems, methods, and non-transitory computer readable media are configured to determine at least one category corresponding to the at least one seed content item and determine one or more interests that are associated with the at least one category.

In an embodiment, the systems, methods, and non-transitory computer readable media are configured to determine one or more interests that are associated with at least one image included in the at least one seed content item.

In an embodiment, the systems, methods, and non-transitory computer readable media are configured to determine at least one content source that is referenced by a link included in the at least one seed content item and determine a set of topic tags using text in the content source, wherein each topic tag describes subject matter reflected in the text, and wherein each topic tag corresponds to an interest.

In an embodiment, the systems, methods, and non-transitory computer readable media are configured to determine a respective score for each interest in the set using a model, wherein the model is trained to determine a score for an interest using a respective set of features that associated with the interest, removing interests in the set having a corresponding score that does not satisfy a threshold score, and ranking the set of interests based at least in part on the respective scores.

In an embodiment, interests in the set that are determined more likely to be selected for promoting the content item are ranked higher than other interests in the set.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example promotion module for promoting content items, according to an embodiment of the present disclosure.

FIG. 2 illustrates an example of an interest suggestion module configured to generate user interests for a content item, according to an embodiment of the present disclosure.

FIG. 3 illustrates an example of an interface through which an a content item can be promoted, according to an embodiment of the present disclosure.

FIG. 4 illustrates an example process for generating interests for promoting a content item, according to an embodiment of the present disclosure.

FIG. 5 illustrates another example process for generating interests for promoting a content item, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Promoting Content Items

Today, people often utilize computing devices (or systems) for a wide variety of purposes. Users can use their computing devices to, for example, interact with one another, access content, share content, and create content. In some cases, content items can include postings from members of a social networking system. The postings may include text and media content items, such as images, videos, and audio. The postings may be published to the social networking system for consumption by others.

In some instances, a promoting user (e.g., advertiser) of the social networking system may seek to promote a content item to other users of the social networking system. When being promoted, the content item can be presented to other users, for example, as an advertisement or suggestion. The promoted content item can include a hypertext link that enables the user to navigate to another page or display relating to the content item. In various embodiments, the content item being promoted may be a page accessible through the social networking system, a website (or Uniform Resource Locator) associated with a page that is accessible through the social networking system, and/or a post that is accessible through the social networking system. In general, pages and posts can be accessed through the social networking system. A page may correspond to an entity (e.g., a business, topic, location, user, etc.). Users of the social networking system can navigate to the page to learn more about the entity as well as access and/or post content through the page. Such content may include text and/or media content items, such as images, videos, and audio. Users of the social networking system have the option to be associated with the page, for example, by “liking” the page (e.g., selecting a “like” option through the social networking system) or disliking the page. A user that is associated with a page can be referred to as a “fan” or someone who has “fanned” the page. A post may be a content item (e.g., text, media, etc.) that is provided by a user of the social networking system. Posts can be surfaced through a page or newsfeed. Further, users can interact with posts, for example, by posting comments or replies, liking (or disliking) the post, and/or sharing the post.

Typically, a user can promote a content item by providing a list of interests that relate to the content item as well as a spending budget for promoting the content item. The content item can then be promoted through the social networking system to users that have specified, or demonstrated, any interests that match the interests included in the list. For example, a content item can be associated with the interests “camping”, “backpacking”, and “outdoors” and a daily spend of $10 may be allotted for promoting the content item. In this example, promotion of the content item can be targeted at users of the social networking system that have specified, or demonstrated, an interest in at least one of “camping”, “backpacking”, and “outdoors”. The promotion of the content item can continue until the daily spending budget of $10 has been exhausted. As evident, the interests specified for a content item can play an important role in effectively promoting that content item to the appropriate user audience. However, the task of determining which interests are appropriate for content items can be difficult for some users, especially those that are unsophisticated in terms of promoting content items. Under conventional approaches, therefore, users seeking to promote content items may end up supplying sub-optimal interests for promoting the content items, thereby resulting in ineffective targeting of users and wasted resources. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, interests can be automatically suggested to users based on the content item being promoted. For example, a user seeking to promote a page for their coffee shop can be provided “latte”, “café ”, and “pastries” as a set of suggested interests. The suggested interests can be determined, for example, based in part on the interests that were used to promote content items that are similar, or related, to the page being promoted. The promoting user has the option to accept or decline any of the suggested interests for purposes of promoting the page. As a result, the improved approach can provide users with an optimal set of suggested interests for promoting any given content item, thereby effectively targeting the appropriate user audience while optimizing the use of spending resources.

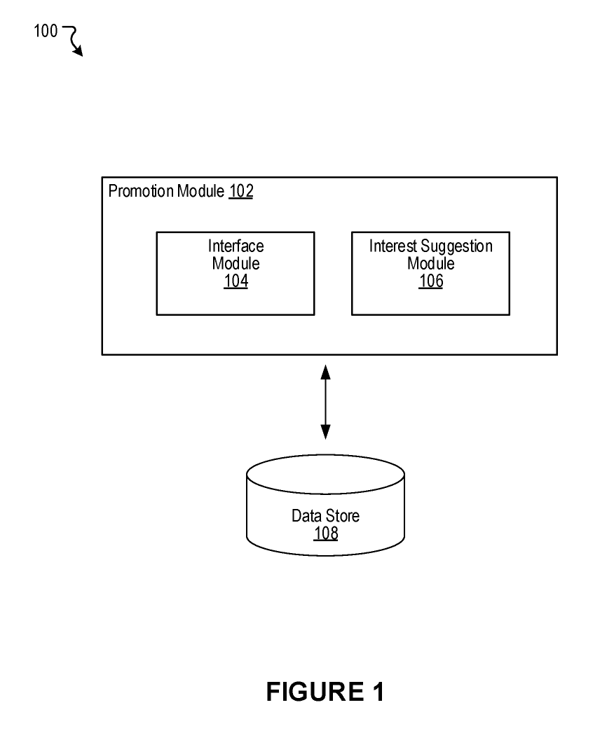

FIG. 1 illustrates an example system 100 including an example promotion module 102 for promoting content items, according to an embodiment of the present disclosure. As shown in the example of FIG. 1, promotion module 102 can include an interface module 104 and an interest suggestion module 106. In some instances, the example system 100 can include at least one data store 108. The components (e.g., modules, elements, etc.) shown in this figure and all figures herein are exemplary only, and other implementations may include additional, fewer, integrated, or different components. Some components may not be shown so as not to obscure relevant details.

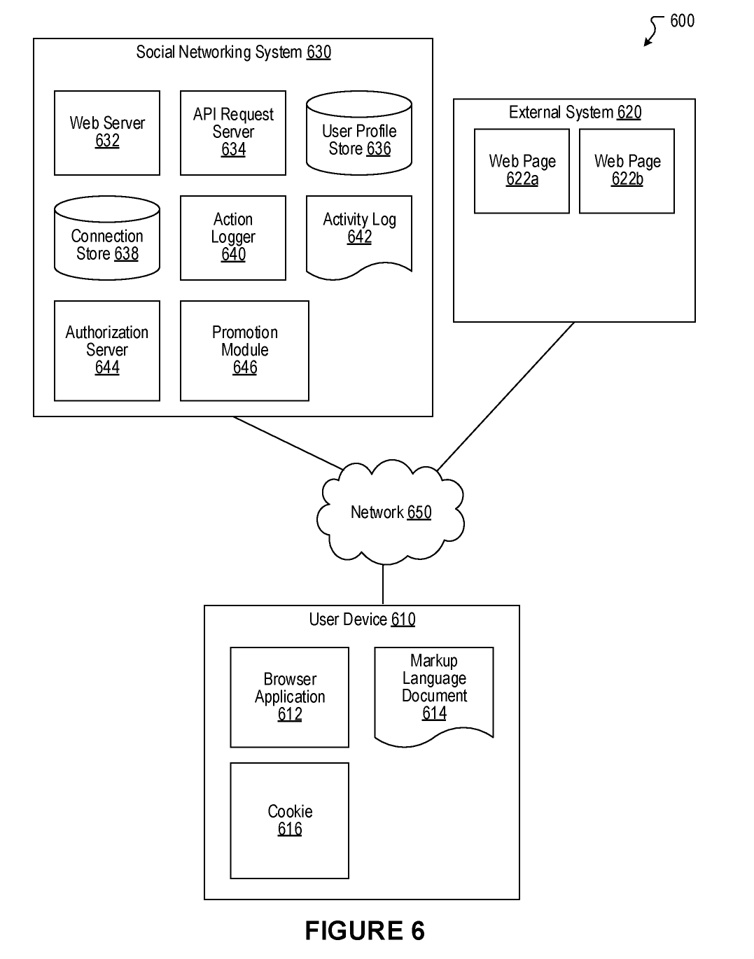

In some embodiments, the promotion module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the promotion module 102 can be implemented, in part or in whole, as software running on one or more computing devices or systems, such as on a user or client computing device. In one example, the promotion module 102 or at least a portion thereof can be implemented as or within an application (e.g., app), a program, or an applet, etc., running on a user computing device or a client computing system, such as the user device 610 of FIG. 6. In another example, the promotion module 102 or at least a portion thereof can be implemented using one or more computing devices or systems that include one or more servers, such as network servers or cloud servers. In some instances, the promotion module 102 can, in part or in whole, be implemented within or configured to operate in conjunction with a social networking system (or service), such as the social networking system 630 of FIG. 6.

The promotion module 102 can be configured to communicate and/or operate with the at least one data store 108, as shown in the example system 100. The at least one data store 108 can be configured to store and maintain various types of data including respective interests that have been utilized for promoting content items over various periods of time. In some implementations, the at least one data store 108 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 108 can store information associated with users, such as user identifiers, user information, profile information, user specified settings, content produced or posted by users, and various other types of user data.

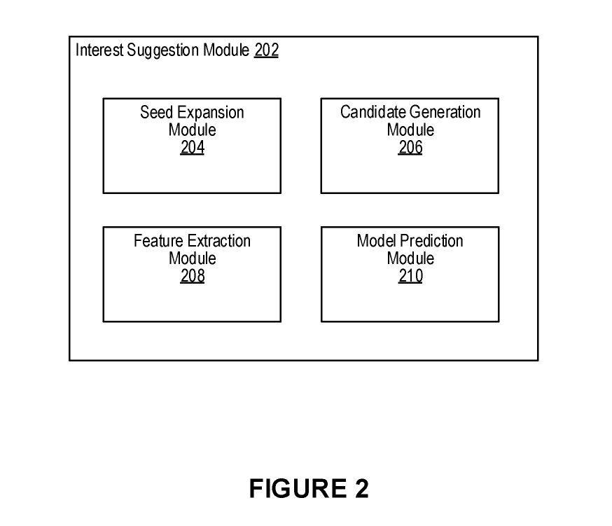

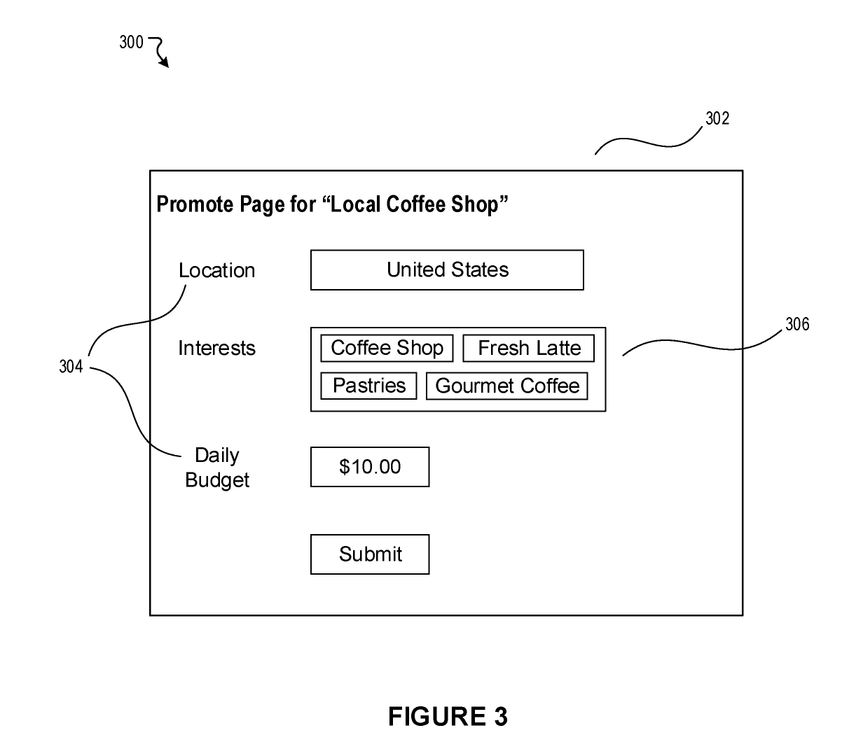

In various embodiments, the interface module 104 can be configured to provide an interface through which a user can promote content items. In various embodiments, upon selecting a content item to promote, the user can be provided, through the interface, a set of suggested interests to use for promoting the content item. More details regarding the interface will be provided below with reference to FIG. 3. The interest suggestion module 106 can be configured to determine suggested interests for content items. For example, the interest suggestion module 106 can utilize various information, such as the content item to be promoted, to determine a set of interests that may be used to effectively target the content item to an appropriate user audience. More details regarding the interest suggestion module 106 will be provided below with reference to FIG. 2.

FIG. 2 illustrates an example of an interest suggestion module 202 configured to generate user interests for a content item, according to an embodiment of the present disclosure. In some embodiments, the interest suggestion module 106 of FIG. 1 can be implemented as the interest suggestion module 202. As shown in FIG. 2, the interest suggestion module 202 can include a seed expansion module 204, a candidate generation module 206, a feature extraction module 208, and a model prediction module 210.

As mentioned, the interest suggestion module 202 can be configured to determine a set of suggested interests for a content item being promoted. The content item being promoted can be associated with one or more interests and these interests can be utilized by the social networking system to promote, or target, the content item to users that have indicated, or demonstrated, one or more interests that match the interests that are associated with the content item.

Once a content item is selected to be promoted, the seed expansion module 204 can generate a list of suggested interests for the content item. As described below, this list can be ranked so that the suggested interests that are more effective in promoting the content item are ranked higher in the list. To generate the list of suggested interests, in various embodiments, the seed expansion module 204 can obtain a set of seed content items that are related to the content item being promoted. In some embodiments, the seed expansion module 204 can generate the set of seed content items using collaborative filtering. In some embodiments, the seed expansion module 204 can generate the set of seed content items based on co-visitation. In such embodiments, a model (e.g., Markov model) can be generated for capturing similarity through user activity. This model can predict a transition probability between two content items (e.g., from a page, tag, group, profile, or post to a different page, tag, group, profile, or post). For example, if a user is accessing page A, the model can predict a likelihood that the user will next visit page B. In this example, the transition likelihoods can be used to determine a set of seed content items that each have a threshold likelihood of being transitioned to and from the content item being promoted.

In some embodiments, the seed expansion module 204 can generate the set of seed content items based on co-interaction data. For example, co-interaction graph data can describe user interactions (e.g., production, clicking, viewing, navigating, fanning sequences) with content items. In such embodiments, content items can be clustered based, in part, on the user interactions. Thus, content items included in a cluster are related to one another to some degree. Here, content items included in a cluster that is associated with the content item to be promoted can be used as seeds.

Seed content items can be used by the candidate generation module 206 to generate candidate interests for the content item being promoted using one or more techniques. Some, or all, of these candidate interests can then be presented as suggested interests for the content item being promoted. In some embodiments, the candidate generation module 204 can generate candidate interests by obtaining a set of topic tags that describe the subject matter reflected in the seed content items. Each tag can be made up of one or more terms that provide some description of the seed content item. For example, a page for “Bob's Burritos” may be associated with the tags “Mexican food”, “burritos”, “fast food”, to name some examples. In one example, the set of tags can be determined based in part on the title of a page, the page's description, and/or other content included in the page (e.g., posts, text and/or media included in the posts, etc.). In another example, when promoting a post, the set of tags can be determined based in part on the text and/or media (e.g., images, videos, audio, etc.) included in the post. In some embodiments, each topic tag corresponds to an interest. Therefore, in such embodiments, the tags associated the seed content item can be used as candidate interests for the content item being promoted.

In some embodiments, the candidate generation module 204 can generate candidate interests for the content item being promoted by surfacing interests using fans of the seed content items. For example, the candidate generation module 204 can identify fans of the seed content items. For each fan, the candidate generation module 204 can obtain information describing one or more interests of the fan. This fan-to-interest mapping can be used to determine which interests correspond to fans of each of the seed content items. Next, the candidate generation module 204 can perform collaborative filtering on this data to determine respective interests that tend to be used to target fans of the seed content items. For example, fans of a first coffee shop page may tend to be targeted using interests “coffee”, “latte”, “café ” while fans of a second coffee shop page may tend to be targeted using interests “chai”, “latte”, “café ”. In some embodiments, the candidate generation module 204 can determine interests that are shared among the different seed content items and some, or all, of these shared interests can then be used as candidate interests for the content item being promoted. In the example above, the shared interests include “latte” and “café ”.

In some embodiments, the candidate generation module 204 can generate candidate interests for the content item being promoted by determining a set of interests that were previously used to promote the seed content items. For example, the candidate generation module 204 can determine which interests were used for boosting, or promoting, a seed content item over some period of time (e.g., past month, past quarter, past year, etc.). These previously-used interests can be aggregated and used as candidate interests for the content item being promoted. For example, if the seed content item is a page, the candidate generation module 204 can determine the various interests that were historically selected for promoting the page. Similarly, if the seed content item is a post, the candidate generation module 204 can determine the various interests that were historically selected for promoting the post.

In some embodiments, the candidate generation module 204 can generate candidate interests based on one or more categories corresponding to the content item being promoted. For example, content items can be categorized into one or more categories based on their subject matter and/or the entity (e.g., a business, topic, location, user, etc.) associated with the content item. In one example, a page corresponding to a coffee shop can be categorized in the restaurant category, coffee shop category, and/or food & beverage category. Each interest used in a given category can be associated with a corresponding count indicating the number of times the interest was used in the category across various promotion campaigns. In some instances, each interest can be associated with a score indicating how strongly the interest corresponds to a category. This score for an interest can be determined based, in part, on the corresponding count indicating the number of times the interest was used in a category. Using this information, the candidate generation module 204 can apply collaborative filtering to determine a set of interests that are most highly correlated with each of the categories. This set of interests, or a portion thereof, can then be used as candidate interests for the content item being promoted.

In some embodiments, the candidate generation module 204 can generate candidate interests based on the subject matter that is associated with the content item being promoted. For example, a page may link to content (e.g., a website or any content that is linked using a Uniform Resource Locator). In this example, the text in the linked content can be scraped and one or more tags that describe the text can be obtained. In some embodiments, each tag corresponds to an interest. Therefore, in such embodiments, the tags obtained can be used as candidate interests for the content item being promoted. In one example, the interests can be determined from topics that are scraped from a website that is associated with a page. In another example, the interests can be determined from scraped topics of any Uniform Resource Locators (URLs) mentioned as shares in posts made by users.

In some embodiments, seed pages and/or posts may include media (e.g., images, videos, audio, etc.). In such embodiments, the media can be analyzed to obtain a set of corresponding hash tags that describe the subject matter reflected in the media. For example, a post that includes an image of a coffee cup may be associated with a hash tag “#coffee”. In this example, other content items that also included media with the hash tag “#coffee” can be identified. In various embodiments, collaborative filtering can be applied to these content items and their corresponding hash tags to determine the most common interests that are used for content items that include those hash tags. These interests can then be used as candidate interests for the content item being promoted. In some embodiments, the media can be analyzed by applying a machine learning model (image classifier) to the media. In particular, a probability regarding whether the media reflects predetermined subject matter can be determined. The image classifier can be based on any machine learning technique, including but not limited to a deep convolutional neural network. For example, the image classifier can be trained and tested to determine the subject matter reflected by an image. In a development phase, contextual cues for a sample set of images can be gathered. Images classes corresponding to various subject matter can be determined. Correlation of the sample set of images with the image classes based on the contextual cues can be determined. A training set of images can be generated from the sample set of images based on scores indicative of high correlation. The training set of images can be used to train the image classifier to generate visual pattern templates of the image classes. In an evaluation phase, the image classifier can be applied to a new image to determine the subject matter reflected by the new image.

Once all of the candidate interests have been generated using some, or all, of the techniques described above, the feature extraction module 208 can be configured to extract features from each of the candidate interests. These features can be used to rank the candidate interests using a model. The features that may be extracted from the candidate interests include, for example, the sources (e.g., topic tags, historical usage, categories, etc.) from which a candidate interest was determined, the number of promotion campaigns that have previously used the candidate interest in promoting content items, the precision (or recall) at which the candidate interest was accepted as a suggestion in previous promotion campaigns, the precision (or recall) of the promoting user (e.g., advertiser) that is promoting, or boosting, the content item, the number of fans of the content item being promoted, to name some examples.

The model prediction module 210 can be configured to generate a respective score for each candidate interest. In some embodiments, once the scores have been generated, the model prediction module 210 can be configured to return a threshold number of the highest ranking candidate interests. Some, or all, of these highest ranking candidate interests can then be presented as suggested interests, for example, through a promotion user interface, as described in reference to FIG. 3. In various embodiments, the model can be implemented as a boosted decision tree. For each candidate interest, the model can receive respective features that correspond to the candidate interest as input and can output a respective score, or probability, that a promoting user will incorporate the candidate interest in their promotion campaign for the content item being promoted. Candidate interests that have a score that does not satisfy a threshold value can be filtered and removed from the list of interests that are provided as suggestions to the promoting user.

FIG. 3 illustrates an example 300 of an interface 302 through which a content item can be promoted, according to an embodiment of the present disclosure. In this example, the interface 302 is presented on a display screen of a computing device. Further, the interface 302 may be provided through an application (e.g., a web browser, a social networking application, etc.) running on the computing device. In the example of FIG. 3, a user operating the computing device can interact with the interface 302 to promote a content item. When promoting the content item, the user can specify various targeting criteria 304, such as the geographic region (e.g., a region, country, state, zip code, etc.) as well as a spending budget for the promotion campaign. The user can also specify interests 306. The content item can then be promoted to users that have specified, or demonstrated, any interests that match the interests 306. In some embodiments, the interests 306 are automatically populated in the interface 302 using the approaches described above. The promoting user has the option to accept or decline any of the suggested interests 306.

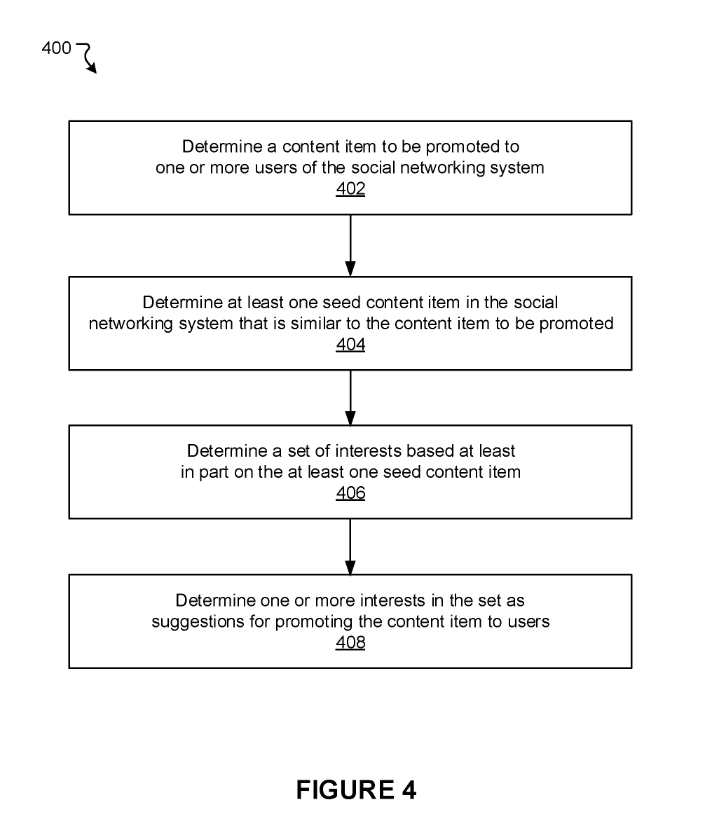

FIG. 4 illustrates an example process 400 for generating interests for promoting a content item, according to an embodiment of the present disclosure. It should be appreciated that there can be additional, fewer, or alternative steps performed in similar or alternative orders, or in parallel, within the scope of the various embodiments discussed herein unless otherwise stated. At block 402, a content item to be promoted to one or more users of the social networking system can be determined. At block 404, at least one seed content item in the social networking system that is similar to the content item to be promoted can be determined. At block 406, a set of interests can be determined based at least in part on the at least one seed content item. At block 408, one or more interests in the set can be determined as suggestions for promoting the content item to users, wherein promoting the content item using a first interest causes the content item to be presented to users of the social networking system that are associated with the first interest.

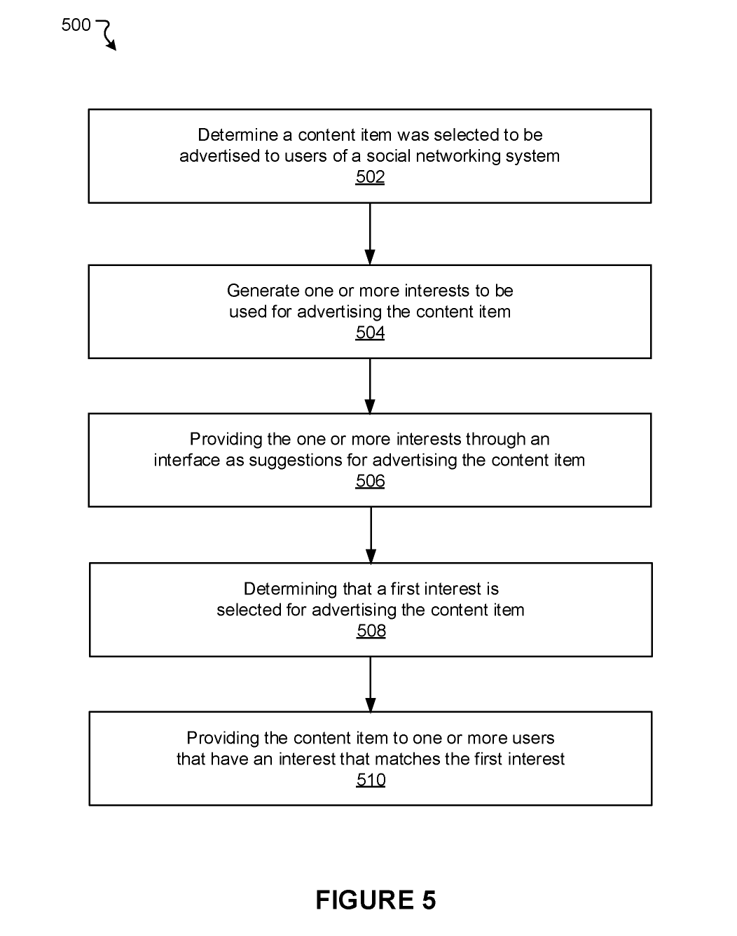

FIG. 5 illustrates another example process 500 for generating interests for promoting a content item, according to an embodiment of the present disclosure. It should be appreciated that there can be additional, fewer, or alternative steps performed in similar or alternative orders, or in parallel, within the scope of the various embodiments discussed herein unless otherwise stated. At block 502, a determination is made that a content item was selected to be advertised to users of a social networking system. At block 504, one or more interests to be used for advertising the content item are generated. At block 506, the one or more interests are provided through an interface as suggestions for advertising the content item. At block 508, a determination is made that a first interest is selected for advertising the content item. At block 510, the content item is provided to one or more users that have an interest that matches the first interest.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a promotion module 646. The promotion module 646 can, for example, be implemented as the promotion module 102 of FIG. 1. As discussed previously, it should be appreciated that there can be many variations or other possibilities.

### Hardware Implementation

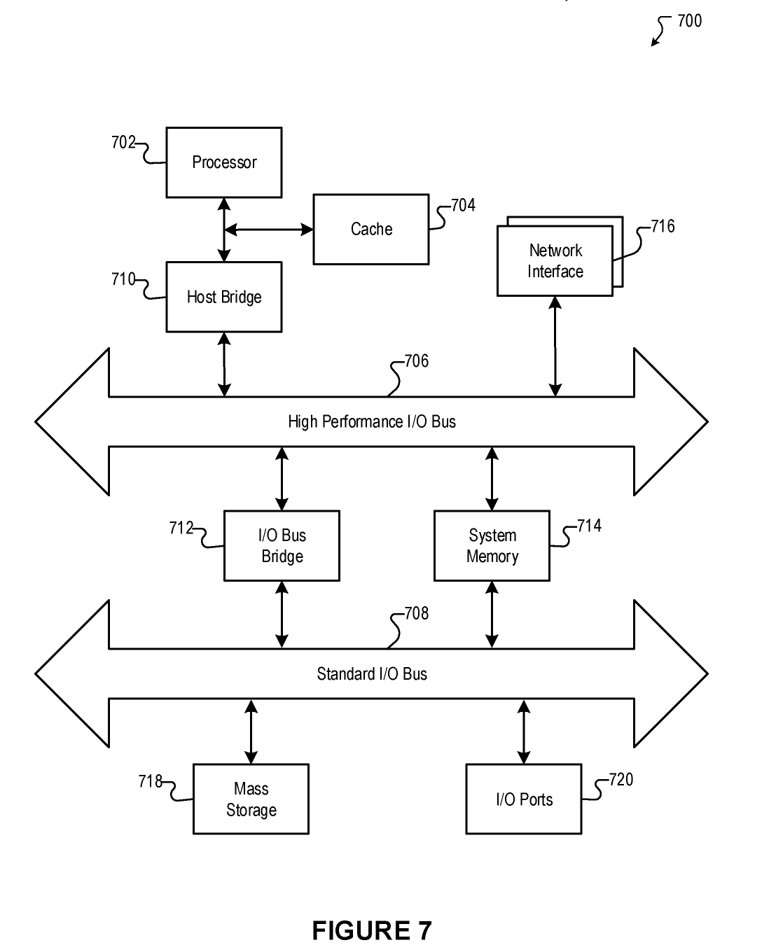

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a social networking system, a content item to be promoted to one or more users of the social networking system;
determining, by the social networking system, at least one seed content item in the social networking system that is similar to the content item to be promoted;
determining, by the social networking system, a set of interests based at least in part on the at least one seed content item; and
determining, by the social networking system, one or more interests in the set as suggestions for promoting the content item to users, wherein promoting the content item using a first interest causes the content item to be presented to users of the social networking system that are associated with the first interest.

2. The computer-implemented method of claim 1, wherein the content item is one of a page accessible through the social networking system, a website associated with a page that is accessible through the social networking system, or a post that is accessible through the social networking system.

3. The computer-implemented method of claim 1, wherein determining the set of interests based at least in part on the at least one seed content item further comprises:
determining, by the social networking system, a set of topic tags using the at least one seed content item, wherein each topic tag describes subject matter reflected in the seed content item, and wherein each topic tag corresponds to an interest.

4. The computer-implemented method of claim 1, wherein determining the set of interests based at least in part on the at least one seed content item further comprises:
determining, by the social networking system, one or more interests that are used to target fans of the at least one seed content item.

5. The computer-implemented method of claim 1, wherein determining the set of interests based at least in part on the at least one seed content item further comprises:
determining, by the social networking system, one or more interests that have previously been used to promote the at least one seed content item over a period of time.

6. The computer-implemented method of claim 1, wherein determining the set of interests based at least in part on the at least one seed content item further comprises:
determining, by the social networking system, at least one category corresponding to the at least one seed content item; and
determining, by the social networking system, one or more interests that are associated with the at least one category.

7. The computer-implemented method of claim 1, wherein determining the set of interests based at least in part on the at least one seed content item further comprises:
determining, by the social networking system, one or more interests that are associated with at least one image included in the at least one seed content item.

8. The computer-implemented method of claim 1, wherein determining the set of interests based at least in part on the at least one seed content item further comprises:
determining, by the social networking system, at least one content source that is referenced by a link included in the at least one seed content item; and
determining, by the social networking system, a set of topic tags using text in the content source, wherein each topic tag describes subject matter reflected in the text, and wherein each topic tag corresponds to an interest.

9. The computer-implemented method of claim 1, wherein determining the one or more interests in the set as suggestions further comprises:
determining, by the social networking system, a respective score for each interest in the set using a model, wherein the model is trained to determine a score for an interest using a respective set of features that associated with the interest;
removing, by the social networking system, interests in the set having a corresponding score that does not satisfy a threshold score; and
ranking, by the social networking system, the set of interests based at least in part on the respective scores.

10. The computer-implemented method of claim 9, wherein interests in the set that are determined more likely to be selected for promoting the content item are ranked higher than other interests in the set.

11. A system comprising:
at least one processor; and
a memory storing instructions that, when executed by the at least one processor, cause the system to perform:
determining a content item to be promoted to one or more users of the social networking system;
determining at least one seed content item in the social networking system that is similar to the content item to be promoted;
determining a set of interests based at least in part on the at least one seed content item; and
determining one or more interests in the set as suggestions for promoting the content item to users, wherein promoting the content item using a first interest causes the content item to be presented to users of the social networking system that are associated with the first interest.

12. The system of claim 11, wherein the content item is one of a page accessible through the social networking system, a website associated with a page that is accessible through the social networking system, or a post that is accessible through the social networking system.

13. The system of claim 11, wherein determining the set of interests based at least in part on the at least one seed content item further causes the system to perform:
determining a set of topic tags using the at least one seed content item, wherein each topic tag describes subject matter reflected in the seed content item, and wherein each topic tag corresponds to an interest.

14. The system of claim 11, wherein determining the set of interests based at least in part on the at least one seed content item further causes the system to perform:
determining one or more interests that are used to target fans of the at least one seed content item.

15. The system of claim 11, wherein determining the set of interests based at least in part on the at least one seed content item further causes the system to perform:
determining one or more interests that have previously been used to promote the at least one seed content item over a period of time.

16. A non-transitory computer-readable storage medium including instructions that, when executed by at least one processor of a computing system, cause the computing system to perform a method comprising:
determining a content item to be promoted to one or more users of the social networking system;
determining at least one seed content item in the social networking system that is similar to the content item to be promoted;
determining a set of interests based at least in part on the at least one seed content item; and
determining one or more interests in the set as suggestions for promoting the content item to users, wherein promoting the content item using a first interest causes the content item to be presented to users of the social networking system that are associated with the first interest.

17. The non-transitory computer-readable storage medium of claim 16, wherein the content item is one of a page accessible through the social networking system, a website associated with a page that is accessible through the social networking system, or a post that is accessible through the social networking system.

18. The non-transitory computer-readable storage medium of claim 16, wherein determining the set of interests based at least in part on the at least one seed content item further causes the computing system to perform:
determining a set of topic tags using the at least one seed content item, wherein each topic tag describes subject matter reflected in the seed content item, and wherein each topic tag corresponds to an interest.

19. The non-transitory computer-readable storage medium of claim 16, wherein determining the set of interests based at least in part on the at least one seed content item further causes the computing system to perform:
determining one or more interests that are used to target fans of the at least one seed content item.

20. The non-transitory computer-readable storage medium of claim 16, wherein determining the set of interests based at least in part on the at least one seed content item further causes the computing system to perform:
determining one or more interests that have previously been used to promote the at least one seed content item over a period of time.
